(19) United States
(12) Patent Application Publication
(10) Pub. No.: US 2007/0166440 A1
(43) Pub. Date: Jul. 19, 2007

(54) Method for supressing post-harvest biological infestation and disease in fruit

(75) Inventors: Ian Davie, Markham (CA); Roman Kinasz, Toronto (CA)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: THE INTERNATIONAL GROUP, Toronto, ON (CA)

(21) Appl. No.: 11/568,434

(22) PCT Filed: Apr. 28, 2005
(86) PCT No.: PCT/US05/14795

§ 371 Date: Oct. 27, 2006

Related U.S. Application Data
(60) Provisional application No. 60/566,577, filed on Apr. 29, 2004.
(60) Provisional application No. 60/566,548, filed on Apr. 29, 2004.

(51) Int. Cl. A23L 3/34

(52) U.S. Cl. 426/323; 426/615

(57) ABSTRACT

A method for suppressing post-harvest biological infestation in fruits, such as bananas, plantains, and pineapples, is provided. The method involves treating the cut or separated areas of the fruit by applying a composition containing: (a) a synthetic film-forming thermoplastic polymer in an amount effective to suppress biological infestation and disease of the fruit when applied; and (b) an oil or aqueous emulsion carrier. Application of these coating compositions may be performed by dipping, extrusion, spraying, or brushing at ambient or elevated temperature, depending on the nature of the coating. The resulting coatings reduce the exposure of the fruit to fungal spores, oxygen, moisture and microorganisms, diminish the occurrence of fungal growth, limit infection, and inhibit microbial growth.

### CROSS-REFERENCE TO RELATED APPLICATION

This application claims the benefit of U.S. provisional patent applications Nos. 60/566,577 and 60/566,548, both filed Apr. 29, 2004.

### BACKGROUND OF THE INVENTION

Upon harvesting, bananas become susceptible to attack by a number of fungi, often resulting in the incidence of disease beginning on the cut surface of the clusters. Crown rot, in particular, can result in the rotting of the cluster tissue, down through the neck of the fingers, and ultimately through the entire fruit. The current method of controlling this condition has been the post-harvest application of fungicides to banana crowns. While effective, this approach results in undesirable exposure of the consumer to harmful pesticides.

When bananas are cut from the bunches at harvest, exudation of latex from the fruit through the cut surface is also problematic: since the latex discolors to brown upon drying, staining of the fruit and the packaging materials occurs. Such a problem is typically overcome by subjecting the cut clusters to a delatexing step, but this requires a lengthy residence in a bath of an alum solution.

Similarly, cut pineapples are also susceptible to fungal infection. As pineapples are harvested upon ripening, the fruit is removed from the plant by cutting or twisting it from the stalk in close proximity to the bottom of the fruit, the butt. The tissue exposed by the cut is high in moisture, as juices from the pineapple are able to escape the fruit. As a result, this region becomes highly susceptible to attack by a number of fungi. Fungal infections of pineapple butts can result in the development of disease in the harvested fruit, most notably butt rot and butt mold. Both of these conditions can have serious economic consequences as a result of loss of fruit.

Methods which utilize waxes to treat banana crowns and reduce decomposition are known (see, for example WO 2004/37006 and GB 348,755). However, such hot melt coatings of waxes may pose application problems as they can stick to the packaging materials used with the bananas and may also rub off during handling and transportation, resulting in reduced performance.

Another prior art method described in JP SHO 59-227238 utilizes water soluble resins to completely coat a fruit in an effort to reduce moisture evaporation which causes desiccation and weight loss of the fruit. However, these materials have limited capabilities to reduce microbial and fungal growth and require the use of fungicide adjuvants. When using such resins, it is also necessary to treat the entire fruit in order to achieve the desired effect.

Finally, JP SHO 61-195645 describes vinyl acetate and plasticizer coatings (applied at 150° C.) for treating whole persimmon fruits to reduce physical damage during shipment. However, no protection from microbial or fungal decomposition is described. Further, in addition to the cost and inconvenience of applying a coating at this temperature, such a high temperature would cause damage to fruits with thin skins or rinds, such as bananas.

There thus remains a need in the art for a method of suppressing biological infestation and diseases in recently harvested fruit, such as bananas and pineapples, which minimizes exposure to harmful pesticides and does not require costly equipment. Ideally, such a method would also prevent staining problems resulting from latex exudation and discoloration.

### BRIEF SUMMARY OF THE INVENTION

A method for treating fruit post-harvest to suppress biological infestation and disease comprises applying to substantially only cut or separated areas of the fruit post-harvest a liquid composition comprising at least one synthetic film-forming thermoplastic polymer and at least one vehicle selected from the group consisting of oils and aqueous emulsions, wherein the at least one polymer is present in the composition in an amount effective to suppress biological infestation and disease of the fruit when applied.

### DETAILED DESCRIPTION OF THE INVENTION

This invention is directed to an alternative approach to suppressing biological infestation and controlling the development of fungal growth on the surfaces of fruit, such as bananas, plantains, and pineapples, which involves creating a physical barrier between the vulnerable surfaces and the surroundings. The protective coatings which are applied to the fruit post-harvest are used to seal the crowns of the bananas or the butts of the pineapples and to reduce the exposure of the crowns or butts to fungal spores and microorganisms. Such coatings thus aid in diminishing the occurrence of fungal growth and limit infection by the fungi that cause diseases, such as crown rot and butt rot. Similarly, limiting the exposure of the banana skins and the moist cut regions of pineapples to moisture and oxygen inhibits microbial growth that causes diseases. Barrier coatings of the nature described also function as a seal for the banana crowns, minimizing the release of latex from the crowns and avoiding the accompanying staining problems.

This invention more specifically relates to a method for suppressing biological infestation and fruit diseases post-harvest by applying specific polymeric coating compositions to substantially only cut or separated areas of the fruit. These coatings, which are described in more detail below, may be applied to the crowns of banana or plantain clusters or to pineapple butts in order to provide a physical barrier, excluding fungal spores as well as moisture and oxygen. As described in further detail below, the coatings may also serve as supports into which antimicrobial or antifungal agents may be incorporated to provide further protection against the development of fungal infections, while avoiding direct application to the fruit. Alternatively or additionally, desiccants that may aid in controlling the release of moisture from the cut or separated region may be added to the coatings. Applying these coatings to the crowns of bananas also contains the release of latex from the crowns in the packaging process and during transport of the fruit.

The protective polymeric coatings which are applied to the fruit preferably exhibit several specific characteristics in order to provide a suitable barrier for the protection of the area of the cut bananas or the pineapple butts which are vulnerable to attack. For example, the coating materials preferably adhere firmly to the skin or butt and completely enclose the cut or separated area. This poses a particular challenge, as this area is typically high in moisture, both from latex or pineapple juice that may be exuding from the cut, as well as from water from baths that are used in post-harvest processes.

Second, to maintain the bond between the coating and the fruit while the fruit is in storage or in transport, the material which comprises the coating should remain dimensionally stable and flexible at typical storage temperatures of about 45° F. to about 57° F. (about 7° C. to about 14° C.). Coatings that are too rigid in nature are unable to flex with the surface of the fruit, and breaks of the bond with the surface are likely to occur.

It is also preferable that the barrier coatings do not interfere with other aspects of the packaging process. Specifically, the coatings should resist rubbing off onto any conveying systems or packaging materials into which they may come into contact. For example, bananas and plantains are typically placed into cartons lined with polyethylene, and the banana coatings preferably will not adhere to either the polyethylene or to any exposed portion of the carton. Similarly, pineapples are typically transported in unlined cartons, and the pineapple coatings preferably will not adhere to any portions of the cartons.

The method according to the invention for suppressing biological infestation and fruit diseases comprise applying specific polymeric coating compositions to the fruit post-harvest. Preferably, the coatings are substantially only applied to the cut or separated areas and adjoining areas; it is not necessary and is generally undesirable to apply the coatings to the entire fruit.

Two types of liquid polymeric coating compositions are appropriate for use with the method of the invention, which differ mainly in the type of vehicle or carrier which is included. All of the polymeric compositions comprise at least one synthetic (not naturally-derived) film-forming thermoplastic polymer in an amount effective to suppress biological infestation and disease of the fruit when applied. Exemplary film-forming thermoplastic polymers include, but are not limited to, styrene polymers and copolymers (including styrene-isoprene and styrene-butadiene polymers), acrylic polymers (such as butyl acrylate and acrylic acid, for example), styrene-acrylic polymers, vinyl acetate polymers, ethylene vinyl acetate copolymers, and polyolefins, including, for example, polyethylene homopolymers and ethylene propylene copolymers.

The first type of vehicle or carrier which may be present in the composition is an oil, which functions as a diluent and also enhances the sealing properties of the polymeric composition. The oil may be, without limitation, a petroleum-derived oil, such as a mineral oil, or a plant-derived oil, such as a soybean oil or a partially or fully hydrogenated vegetable oil. Under some situations, it may also be desirable to utilize a mixture of more than one oil and/or more than one thermoplastic film-forming polymer. When an oil is used as a vehicle for the composition, SEBS and polyethylene polymers are most preferred and mineral oil is a particularly preferred vehicle.

In these oil-containing compositions, the film-forming thermoplastic polymer is preferably present in the composition in an amount of about 5 to about 90 weight percent, and the oil is preferably present in an amount of about 10 to about 95 percent by weight. One preferred composition contains about 80 weight % polymer and about 15 weight % oil. In another preferred embodiment, the composition contains predominantly oil and the thermoplastic polymer serves as a gelling agent.

As will be explained in more detail below, the oil-containing polymeric coating compositions may be applied as hot-melt coatings in molten form. Alternatively, for application at or near ambient temperature, the oil-containing polymeric compositions may be applied in the form of aqueous suspensions, aqueous solutions, or solvent-based systems. Appropriate solvents include water, aliphatic alcohols, hydrocarbons, ketones, and esters, for example; water, alcohols and hydrocarbons are most preferred. While not required in aqueous systems, a cosolvent may be desirable to accelerate drying of the coating.

The second type of composition is an aqueous emulsion or dispersion which comprises the synthetic film-forming thermoplastic polymer(s), preferably in latex form. The total amount of latex polymer(s) in the composition is preferably about 15 to about 99% by weight. Styrene butadiene and styrene acrylic polymers are preferred for use in aqueous emulsion compositions according to the invention. The term “emulsion” may be understood to encompass emulsions, dispersions, suspensions, and other similar types of mixtures.

Optionally, the composition may further contain at least one wax, for example, a paraffin wax, a microcrystalline wax, or a naturally derived wax such as carnauba, montan, candelilla or beeswax. Paraffin wax is particularly preferred. The wax, if included, is preferably present in an amount of about 5 to about 20% by weight. A preferred wax-containing composition is an aqueous emulsion containing polyethylene, paraffin wax, water, and various emulsifiers (see Example 6 below).

The use of an aqueous emulsion containing solid latex polymer particles allows the compositions to be applied at or near about ambient temperature, rather than at an elevated temperature. Such emulsions preferably contain about 40 to about 60 weight percent solids. In addition to water, a co-solvent, such as an alcohol, may be included in the composition to accelerate drying.

Additional components may also be included in the coating compositions. For example, emulsifiers and/or surfactants (cationic, non-ionic or anionic) may be desirable to assist in forming emulsions. Appropriate anionic surfactants include neutralized fatty acids and fatty acid sulphate and sulphonate derivatives, and exemplary non-ionic surfactants include alkoxylated alcohols and alkyl phenols, alkoxy derivatives of fatty esters, succinates and sorbitol esters, and poly alkoxylated derivatives, such as ethylene oxide-propylene oxide condensates. Exemplary cationic surfactants for use in the compositions include fatty amines and amides and alkoxylated derivatives thereof. However, the particular surfactant is not critical to the coating compositions and an appropriate surfactant and/or emulsifier may be determined by routine experimentation.

A variety of other components may be included to provide desired properties. Plasticizers (such as but not limited to polymeric plasticizers), such as epoxidized soya derivatives and polyester fatty acid condensates, and resins, such as rosin, rosin derivatives, and hydrocarbon-derived resins, may be incorporated in order to enhance flexibility and adhesion to the fruit. Conventional fillers, such as silica gel, clay, diatomaceous earth, calcite, and silicates, for example, may be included to impart stiffness and opacity to the coatings and to reduce costs. The nature of the coatings may also be modified by including elastomeric polymers, such as butyl rubber, SEBS and other styrene and alpha methyl styrene block copolymers and amorphous polyolefins, thickeners, antifoam agents, antioxidants, natural waxes and/or natural resins which impart specific properties to achieve desired coating characteristics.

Alternatively or additionally, the coating compositions may also include a naturally-derived material, such as natural orange (unbleached) shellac. Shellac is a transparent material made by dissolving a natural resin, lac (secreted by the lac beetle) in alcohol. For example, shellac dispersed in an aqueous emulsion polymeric composition, which was applied to banana crowns under ambient conditions and dried by applying forced warm air, has been found to provide a protective barrier. Other naturally-derived materials which may be included in the coating compositions include cellulose esters, nitrocellulose, modified guar gum, dakar gum and other natural gum bases.

Optionally, for enhanced protection, for example, the coatings may further comprise additional functional components to impart desired properties; the coatings thus function as supports for these components. For example, antimicrobial agents (including fungicides and bactericides, for example) may enhance the protective properties of the coatings. Such agents are well known in the art and include, for example, borates and various organic acids and salts thereof, such as acids and salts of propionic and benzoic acid. Similarly, the addition of alum or other desiccants known in the art, such as calcium chloride, into the coating may be desirable for controlling the moisture present at exposed surfaces of the fruit.

Color may be imparted to the coatings, if desired for cosmetic purposes, by adding dyes or pigments. For example, D&C oil soluble dyes, such as D&C Yellow #11, or dispersions of FD&C pigments, such as FD&C red #40 Aluminum Lake, may be added, preferably at levels of about 0.01 to about 0.1% by weight. These colors may be tailored for enhanced brand identification or aesthetics. Similarly, fragrances or essential oils may be included in the coatings of the invention if desired for marketing or aesthetic purposes. Appropriate fragrances and oils are well known to those in the art.

Barrier properties of the coating materials for use in the method of the invention may be assessed by casting films of the materials onto paper substrates or other supports and determining the transmission rates of moisture vapor through the films by methods known to those skilled in the art. Barriers to other gases, such as oxygen, may be similarly evaluated. However, other measurement techniques known in the art or to be developed would also be applicable for evaluating these coatings.

The barrier coating compositions for use in the method of the invention may be prepared by typical practices and methods known to those skilled in the art for manufacturing each type of coating. Preparation processes and materials should be consistent with those normally ascribed for materials that are to be used in contact with food. For example, oil-containing polymeric coatings may be prepared by combining the desired components in molten form at a temperature above the melt point of the highest melt component and then using agitation until the components have been thoroughly blended.

Likewise, polymeric emulsion coatings may be prepared by mixing the polymeric components with emulsifiers and/or surfactants at a temperature above the softening point of the polymer(s). The aqueous phase is added gradually with high-shear mixing until a uniform emulsion is achieved with the desired solids content. With polymeric materials, this may require the use of a pressurized vessel to maintain the water in a liquid state. The emulsion is then gradually cooled to ambient temperature.

According to the method of the invention, the compositions may be applied to the fruit surfaces by any method known in the art, including spraying, brushing, dipping, or extrusion. From a practical standpoint, coatings are typically applied to bananas by dipping or spraying, and are applied to pineapples by spraying or extrusion. Emulsion coatings, which are preferably applied at or near ambient temperature, may be put on by spray application techniques or by flooding the fruit under a cascade of the coating. Alternatively, this type of coating may be applied to the fruit by dipping the cut or separated portion of the fruit into the coating material.

Coatings containing oil carriers may be applied by spraying or brushing using heated equipment or by dipping the fruit into the coating material maintained in a molten or liquid state at a temperature above the melting point of the material, preferably at about 80° C. to about 145° C., more preferably at about 90° C. to about 140° C. Molten material may also be extruded onto the cut or separated surface. Upon removal of the fruit from the liquid bath or spray, the coating material adhering to the fruit surface dries, yielding a solid, continuous barrier film. Oil-based coatings which are dissolved or dispersed in solvent may also be applied at or near ambient temperature, as described above.

It may be desirable in some situations to dry the coating after application, such as with warm forced air, to facilitate formation of a film and/or to increase evaporation of a solvent, if present. Other methods of application contemplated by those skilled in the art would also be within the scope of the invention, since the method of application of the coating composition is not critical to the method of the invention.

After the polymeric coating compositions have been applied to the fruit, and the solvent, if present, has been removed, the resulting continuous films protect the fruit by reducing exposure to fungal spores, oxygen, moisture and microorganisms, diminishing the occurrence of fungal growth, limiting infection, and inhibiting microbial growth. The coatings also control the release of latex from banana crowns during packaging and transport.

By applying the polymeric protective coatings to fruits, such as bananas, plantains and pineapples, post-harvest, the fruits are protected from biological infestation and microbial growth that results in disease and rot. The coatings further eliminate the need for a delatexing step in the banana harvest process. These coatings are easy to prepare and apply to the fruit, and may be tailored based on the properties desired. Further, using the method of the invention eliminates the need to apply harmful pesticides directly to the surface of the fruit. The coating compositions may be applied at ambient or elevated temperature, depending on the nature of the polymer component. Whereas compositions containing film-forming polymers and oil are preferably applied at temperatures above the melt temperature of the polymeric component (about 80 to about 145° C.), aqueous emulsions may be applied at or near ambient temperatures. Accordingly, appropriate coating compositions may be selected depending on the location at which the fruit will be treated, the cost of capital equipment which is desired, etc. The coating compositions are also desirable because, in contrast with known methods of protection which require treating or coating the entire fruit, only the cut or separated and adjoining surfaces of the fruit are treated to form a physical barrier to microbial and fungal entry. The method of the invention is thus more cost effective than known methods of fruit protection. Finally, the polymeric coating compositions do not stick to packaging materials, which has found to be problematic with known wax-based coatings.

This invention will be understood in conjunction with the following non-limiting examples. In each of these examples, a different coating composition was prepared and applied to both bananas and pineapples. Each of the oil-based coating compositions (Examples 1-5) was prepared in a steel or stainless steel mixing vessel with sufficient heating to melt the thermoplastic components. Intensive stirring with a turbine-style blade was required to adequately mix the components.

### EXAMPLE 1

Oil-Based Coating

This example demonstrates an oil gel formulation containing the following components:

| | Weight |
|---|---|
| Component | Percentage |
| (a) Britol 35 USP Mineral Oil | 91.98 |
| (b) Kraton G 1652 (SEBS) Polymer | 8.5 |
| (c) Evernox 10 (hindered phenolic antioxidant) | 0.02 |

The composition was prepared by heating the mineral oil to 225° F. (about 107° C.), and then adding the Evernox 10, followed by the SEBS polymer with agitation. The material was blended for approximately one hour, until the polymer had completely dissolved into the blend. This composition would be applied to fruit at about 90 to about 100° C.

### EXAMPLE 2

Oil-Based Coating

This example demonstrates a polyethylene blend coating containing the following components:

| | Weight |
|---|---|
| Component | Percentage |
| (a) Epolene C15 Polyethylene | 85 |
| (b) Britol 35 USP Mineral Oil | 15 |

The composition was prepared by melting the polyethylene and heating it to 235° F. (about 113° C.). The mineral oil was then blended in until the composition was completely uniform. This composition would be applied to fruit at about 100 to about 120° C.

### EXAMPLE 3

Oil-Based Coating

This example demonstrates a polyethylene vinyl acetate, vegetable-derived wax blend containing the following components:

| | Weight |
|---|---|
| Component | Percentage |
| (a) Cargill 550 Fully Hydrogenated Soy Bean Oil | 57.0 |
| (b) IGI 5818 Microcrystalline Wax | 15.0 |
| (c) Ateva 2810 EVA Polymer (polyethylene vinyl acetate) | 18.0 |
| (d) Piccotac 1095 (C5) Hydrocarbon Resin | 10.0 |

The composition was prepared by melting and combining components (a) and (b) and heating to 250° F. (about 121° C.). Component (c) was incorporated with agitation and blending was continued until the polymer had completely dissolved into the blend. Component (d) was then blended in for approximately 30 minutes, until the composition was completely uniform. This composition would be applied to fruit at about 75 to about 110C.

### EXAMPLE 4

Oil-Based Coating

This example demonstrates a colored polyethylene blend containing the following components:

| | | Weight |
|---|---|---|
| Component | | Percentage |
| (a) | Epolene C15 Polyethylene | 83.5 |
| (b) | Britol 35 USP Mineral Oil | 15.0 |
| (c) | Opatint OD 11026 Color Concentrate | 1.5 |
| | (FD&C pigment dispersed in vegetable-derived oil) | |

The composition was prepared by melting the polyethylene and heating to 235° F. (about 113° C.). The mineral oil was then blended in until the mixture was completely uniform. The color concentrate was added, with continued blending, until the color was uniformly dispersed. This composition would be applied to fruit at about 100 to about 120° C.

### EXAMPLE 5

Oil-Based Coating

This example demonstrates a polyethylene vinyl acetate/mineral oil blend containing the following components:

| | | Weight |
|---|---|---|
| Component | | Percentage |
| (a) | Escroene AD 2825 EVA Polymer | 80.0 |
| | (polyethylene vinyl acetate) | |
| (b) | Britol 35 USP Mineral Oil | 15.0 |
| (c) | Silvarez ZT 105LT Resin (modified turpene resin) | 5.0 |

The polymer was melted and heated to 250° F. (about 121° C.). The mineral oil was then blended into the molten polymer, and agitation was continued until the composition was uniformly blended. Finally, the resin was added and blended until it was completely dissolved into the polymer blend. This composition would be applied to fruit at about 110 to about 130° C.

### EXAMPLE 6

Emulsion Coating

This example demonstrates a polyethylene emulsion containing the following components:

| | Weight |
|---|---|
| Component | Percentage |
| (a) Water | 56.8 |
| (b) Sodium Metabisulfite (emulsification aid) | 0.2 |
| (c) Ammonium Hydroxide (emulsification aid) | 0.8 |
| (d) Epolene E14 (polyethylene) | 15.0 |
| (e) Epolene C10 (polyethylene) | 5.0 |
| (f) IGI 1240 Paraffin (fully refined paraffin wax) | 15.0 |
| (g) Oleic Acid (emulsifier) | 5.0 |
| (h) Morpholine (emulsifier) | 2.2 |

The composition was prepared by melting component (f) and bringing the temperature to 220° F. (about 104° C.). Components (d) and (e) were then added to component (f) and were blended until melted and completely mixed. Components (g) and (h) were added and were sealed in a vessel that would sustain pressure. In a separate vessel, components (a), (b), and (c) were combined and heated to 210° F. (about 99° C.). The mixture of (a), (b), and (b) was slowly combined with the polymer melt with high shear agitation. Once the addition was completed, the emulsion was cooled to below about 90° F. (about 32° C.). This composition would be appropriate for application at or near ambient temperature.

### EXAMPLE 7

Emulsion Coating

This example demonstrates a styrene-butadiene block copolymer emulsion containing the following components:

| | Weight |
|---|---|
| Component | Percentage |
| (a) Water | 55.98 |
| (b) Kraton 1107 (styrene-isoprene block copolymer) | 25.0 |
| (c) Silvares SA100 (styrene pure monomer resin) | 7.0 |
| (d) Stabilite 10 (hydrogenated rosin ester) | 3.0 |
| (e) 50 USP Mineral Oil | 5.0 |
| (f) Evernox 10 (hindered phenolic antioxidant) | 0.02 |
| (g) Brij 93 (surfactant/emulsifier) | 3.0 |
| (h) Brij 97 (surfactant/emulsifier) | 1.0 |

To form the coating composition, components (b) to (f) were combined in a pressure vessel, heated to 300° F. (about 149° C.) and blended until uniform. The melt was cooled to 250° F. (about 141° C.) and combined with components (g) and (h). Component (a) was added and the mixture was homogenized with high shear agitation until uniform. The mixture was cooled to below 90° F. (about 32° C.). This composition would be appropriate for application at or near ambient temperature.

### EXAMPLE 8

Emulsion coating

This example demonstrates a polyethylene vinyl acetate emulsion containing the following components:

| | Weight |
|---|---|
| Component | Percentage |
| (a) Escorene AD 2825 (ethylene vinyl acetate copolymer) | 39.2 |
| (b) IGI 1248 Paraffin (fully refined paraffin wax) | 5.0 |
| (c) Ethomeen 18/15 (cationic surfactant/emulsifier) | 4.0 |
| (d) Glacial Acetic Acid | 1.8 |
| (e) Water | 50.0 |

Components (a) and (b) were combined in a pressure vessel, heated to 280° F. (about 138° C.), and blending was continued until uniform. The temperature was reduced to 220° F. (about 104° C.), and component (c) was added. In a separate pressure vessel, components (d) and (e) were blended and heated to 220° F. (about 104° C.) under pressure. The two sets of components were combined and mixed with a high intensity mixer (e.g., a rotor-stator high shear mixer) for a period of about thirty minutes. The resulting emulsion was passed through a high pressure homogenizer and cooled to below 90° F. (about 32° C.). This composition would be appropriate for application at or near ambient temperature.

### EXAMPLE 9

Emulsion Coating

This example demonstrates a styrene butadiene latex coating containing the following components:

| | |
|---|---|
| | Weight |
| Component | Percentage |

| | | |
|---|---|---|
| (a) | Rovene 4002 SBR Latex | 96.4 |
| | (styrene-butadiene polymer latex) at 50% | |
| | solids concentration | |
| (b) | Natrosol 250 MH (hydroxyethyl cellulose) | 1.2 |
| (c) | Additional water | 2.4 |

To form this composition, components (b) and (b) were premixed to form a slurry. The slurry was gradually added to component (a) with agitation and allowed to blend for 30 minutes until all of component (b) had dissolved into the blend. The composition was prepared at or near room temperature, and would be appropriate for application at or near ambient temperature.

### EXAMPLE 10

Emulsion Coating

This example demonstrates a styrene acrylic latex coating containing the following components:

| | |
|---|---|
| | Weight |
| Component | Percentage |

| | | |
|---|---|---|
| (a) | Synthemul 18106 Styrene Acrylic Latex | 97.05 |
| | (styrene acrylic polymer emulsion) at 50% | |
| | solids concentration | |
| (b) | Acrysol ASE-60Rheology Modifier | 0.8 |
| | (acrylic emulsion thickener) | |
| (c) | Additional water | 1.2 |
| (d) | Ammonium Hydroxide (28%) | 0.8 |
| | (to adjust pH to 7.5 to 8.5) | |
| (e) | Foamaster DF160L (antifoam agent) | 0.15 |

To form the composition, components (a) and (d) were combined with agitation. Components (b) and (c) were premixed until uniform, then added to the blend of components (a) and (d). The components were blended until the viscosity of the material became constant. Finally, component (e) was added with agitation, until it was blended in uniformly. This composition was prepared at or near room temperature and would be appropriate for application at or near ambient temperature.

### EXAMPLE 11

Emulsion coating

This example demonstrates a vinyl acetate latex coating containing the following components:

| | | Weight |
|---|---|---|
| Component | | Percentage |
| (a) | Airflex 410 Polymer Latex (vinyl acetate/ethylene | 96.5 |
| | copolymer emulsion) at 50% solids content | |
| (b) | Natrosol 250 MH (hydroxyethyl cellulose) | 1.5 |
| (c) | Additional water | 2.0 |

To form this composition, components (b) and (c) were premixed and combined with (a). The mixture was blended until component (b) was completely dissolved into the blend. This composition was prepared at or near room temperature and would be appropriate for application at or near ambient temperature.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for treating fruit post-harvest to suppress biological infestation and disease, wherein the method comprises applying to substantially only cut or separated areas of a fruit post-harvest a liquid composition comprising at least one synthetic film-forming thermoplastic polymer and at least one vehicle selected from the group consisting of oils and aqueous emulsions, wherein the at least one polymer is present in the composition in an amount effective to suppress biological infestation and disease of the fruit when applied.

2. The method according to claim 1, wherein the composition is applied by a method selected from the group consisting of spraying, brushing, dipping, and extrusion.

3. The method according to claim 1, further comprising drying the composition after application.

4. The method according to claim 1, wherein the vehicle is an oil and the composition is applied at about 80° C. to about 145° C.

5. The method according to claim 1, wherein the vehicle is an aqueous emulsion and the composition is applied at or about ambient temperature.

6. The method according to claim 1, wherein the fruit is selected from the group consisting of bananas, plantains, and pineapples.

7. The method according to claim 1, wherein the at least one film-forming thermoplastic polymer is at least one selected from the group consisting of styrene polymers, acrylic polymers, vinyl acetate polymers, and polyolefin polymers.

8. The method according to claim 7, wherein the polyolefin polymer is selected from the group consisting of polyethylene homopolymers and ethylene propylene copolymers.

9. The method according to claim 7, wherein the styrene polymer is selected from the group consisting of styrene-butadiene polymers, styrene-isoprene polymers, and styrene-acrylic polymers.

10. The method according to claim 1, wherein the carrier is an oil and is at least one selected from the group consisting of petroleum-derived oils and plant-derived oils.

11. The method according to claim 10, wherein the plant-derived oil comprises a soybean oil.

12. The method according to claim 10, wherein the petroleum-derived oil comprises a mineral oil.

13. The method according to claim 1, wherein the composition further comprises at least one of an emulsifier and a surfactant.

14. The method according to claim 1, wherein the composition further comprises a desiccant.

15. The method according to claim 14 wherein the desiccant is at least one selected from the group consisting of calcium chloride and alum.

16. The method according to claim 1, wherein the composition further comprises at least one antimicrobial agent.

17. The method according to claim 16, wherein the antimicrobial agent is at least one selected from the group consisting of fungicides and bactericides.

18. The method according to claim 17, wherein the bactericide is at least one selected from the group consisting of borates, propionic acid and salts thereof, and benzoic acid and salts thereof.

19. The method according to claim 1, wherein the composition further comprises at least one wax.

20. The method according to claim 19, wherein the wax is at least one selected from the group consisting of paraffin wax, microcrystalline wax, and naturally-derived wax.

21. The method according to claim 20, wherein the naturally-derived wax is selected from the group consisting of carnauba wax, montan wax, candelilla wax, and beeswax.

22. The method according to claim 1, wherein the composition further comprises a naturally-derived material selected from the group consisting of shellac, cellulose esters, nitrocellulose, modified guar gum, dakar gum, and natural gum base.

23. The method according to claim 1, wherein the vehicle is an aqueous emulsion and wherein the at least one polymer is provided in latex form.

24. The method according to claim 1, wherein the suppression comprises reducing exposure of the fruit to at least one selected from the group consisting of fungal spores, oxygen, moisture, and microorganisms.

25. The method according to claim 1, wherein the suppression comprises diminishing occurrence of fungal growth in or on the fruit.

26. The method according to claim 1, wherein the suppression comprises limiting infection of the fruit.

27. The method according to claim 1, wherein the suppression comprises inhibiting microbial growth in or on the fruit.

28. The method according to claim 1, wherein the fruit is selected from the group consisting of bananas and plantains, the fruit comprises a crown, and the suppression comprises controlling the release of latex from the crown during packaging and transport.
